(19) United States
(12) Patent Application Publication
(10) Pub. No.: US 2026/0120400 A1
(43) Pub. Date: Apr. 30, 2026

(54) INFORMATION PROCESSING APPARATUS, COMMUNICATION SYSTEM, INFORMATION PROCESSING METHOD, AND NON-TRANSITORY RECORDING MEDIUM

(71) Applicant: Naoki MOTOHASHI, Kanagawa (JP)

(72) Inventor: Naoki MOTOHASHI, Kanagawa (JP)

(21) Appl. No.: 19/332,344

(22) Filed: Sep. 18, 2025

(30) Foreign Application Priority Data
Oct. 28, 2024 (JP) 2024-189242

(51) Int. Cl. G06T 17/00; G06T 7/30

(52) U.S. Cl. CPC G06T 17/00; G06T 7/30; G06T 2207/10028

(57) ABSTRACT

An information processing apparatus includes circuitry that creates a three-dimensional image indicating a replacement target region, the replacement target region being replaceable with a replacement region included in a point cloud obtained by measuring a target object, replaces the replacement target region with the replacement region, based on received input information, and creates a screen including the three-dimensional image.

### CROSS-REFERENCE TO RELATED APPLICATION

This patent application is based on and claims priority pursuant to 35 U.S.C. § 119 (a) to Japanese Patent Application No. 2024-189242, filed on Oct. 28, 2024, in the Japan Patent Office, the entire disclosure of which is hereby incorporated by reference herein.

### BACKGROUND

### Technical Field

The present disclosure relates to an information processing apparatus, a communication system, an information processing method, and a non-transitory recording medium.

### Related Art

To increase the efficiency of tasks and activities on-site such as construction, logistics, and real estate, a digital twin is constructed through measurement using three-dimensional (3D) scanning on-site. A digital twin is a digital copy of a physical-space (or real-world) object (or target object) such as an on-site object (or target object) reproduced in a cyber space (virtual world) created on a computer. The constructed digital twin allows a worker to perform on-site tasks and activities through a communication terminal, such as a computer.

### SUMMARY

The present disclosure described herein provides an information processing apparatus including circuitry. The circuitry creates a three-dimensional image indicating a replacement target region, the replacement target region being replaceable with a replacement region included in a point cloud obtained by measuring a target object; replaces the replacement target region with the replacement region, based on received input information; and creates a screen including the three-dimensional image.

The present disclosure described herein provides a communication system including the above-described information processing apparatus and a measurement apparatus. The measurement apparatus transmits data of the point cloud obtained by measuring the target object to the information processing apparatus.

The present disclosure described herein provides a communication system including the above-described information processing apparatus and a communication terminal. The communication terminal causes a display to display the three-dimensional image.

The present disclosure described herein provides an information processing method including creating a three-dimensional image indicating a replacement target region, the replacement target region being replaceable with a replacement region included in a point cloud obtained by measuring a target object; replacing the replacement target region with the replacement region, based on received input information; and creating a screen including the three-dimensional image.

The present disclosure described herein provides a non-transitory recording medium storing a plurality of instructions which, when executed by one or more processors, causes the one or more processors to perform an information processing method. The information processing method includes creating a three-dimensional image indicating a replacement target region, the replacement target region being replaceable with a replacement region included in a point cloud obtained by measuring a target object; replacing the replacement target region with the replacement region, based on received input information; and creating a screen including the three-dimensional image.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example of a general arrangement of a communication system;

FIG. 2 is a diagram illustrating an example of an electrical hardware configuration of a communication terminal and a server;

FIG. 3 is a diagram illustrating an example of an electrical hardware configuration of a measurement apparatus;

FIG. 4 is a diagram illustrating an example of the functional components of the communication system;

FIG. 5 is an illustration of an example of an image information management table;

FIG. 6 is a sequence diagram illustrating an example of a screen creation and display process of the communication system;

FIG. 7 is a flowchart illustrating an example of a process executed by the server;

FIG. 8 is a flowchart illustrating the example of the process executed by the server;

FIG. 9 is a flowchart illustrating the example of the process executed by the server;

FIG. 10 is a diagram illustrating an example of an initial state of a screen displayed on the communication terminal;

FIG. 11 is a diagram illustrating an example of a point cloud image additionally displayed on the communication terminal based on data of a point cloud;

FIG. 12 is a diagram illustrating an example of a replacement target region displayed in a display area of a three-dimensional image and a replacement region displayed in a display area of the point cloud image on the communication terminal;

FIG. 13 is a diagram illustrating another example of the replacement target region displayed on the communication terminal;

FIG. 14 is a diagram illustrating an example of a changed replacement target region on the communication terminal;

FIG. 15 is a diagram illustrating an example of the screen that has undergone a replacement with the replacement region on the communication terminal; and

FIG. 16 is a diagram illustrating an example of another screen displayed on the communication terminal.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

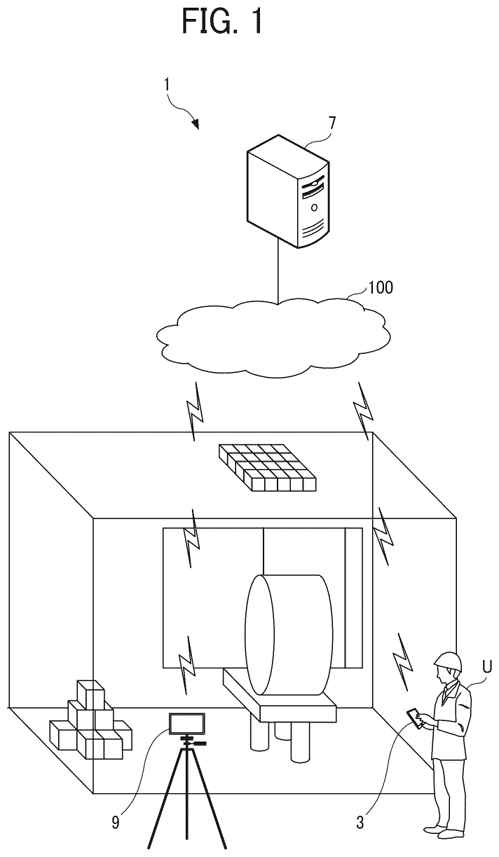

First, a general arrangement of a communication system 1 will be described with reference to FIG. 1. FIG. 1 illustrates a general arrangement of the communication system 1.

As illustrated in FIG. 1, the communication system 1 includes a communication terminal 3, a server 7, and a measurement apparatus 9. The communication terminal 3, the server 7, and the measurement apparatus 9 can communicate with each other via a communication network 100 such as the Internet or a local area network (LAN). The communication may be wired or wireless.

Examples of the communication terminal 3 include a smartphone, a tablet terminal, and a laptop personal computer (PC).

The measurement apparatus 9 irradiates an object (or target object) with laser light and measures reflected light of the laser light to measure the distance from the measurement apparatus 9 to the object.

Data of a point cloud indicating the measurement result acquired by the measurement apparatus 9 may be directly transmitted to the server 7, or may be uploaded (or transmitted) to the server 7 via, for example, the communication terminal 3 or another PC.

When the measurement apparatus 9 is used for on-site measurement, the measurement apparatus 9 is installed on site using a tripod, for example, and the tripod is moved to a plurality of locations on site to perform the measurement. Such measurement thus takes a lot of time and effort.

Since on-site conditions change with the progress of construction and other factors, the measurement involves three-dimensional (3D) scanning of the latest on-site conditions in order to use the latest information for the construction work even though such measurement takes time and effort. In addition, since the construction work is performed gradually, not all, but some, of the on-site areas change daily. For these reasons, it is inefficient to perform time- and effort-consuming measurement work on all the on-site areas.

Accordingly, it is desirable to obtain the latest information on even a location such as an on-site environment where conditions change through efficient measurement.

The server 7 converts the data of the point cloud indicating the measurement result acquired from the measurement apparatus 9 into three-dimensional information for creating a three-dimensional image, or converts the three-dimensional information into the data of the point cloud. The three-dimensional information is information such as a mesh representation obtained by mapping a point cloud to a surface, a building information modeling (BIM) model, or another three-dimensional representation. The server 7 can interchangeably convert between the data of the point cloud and the three-dimensional information.

Further, the server 7 converts data of a point cloud indicating a previous measurement result obtained by measuring on-site conditions in the past into previous three-dimensional information and stores the previous three-dimensional information. In response to a request from the communication terminal 3, the server 7 creates a previous three-dimensional image based on the previous three-dimensional information and transmits the previous three-dimensional image to the communication terminal 3.

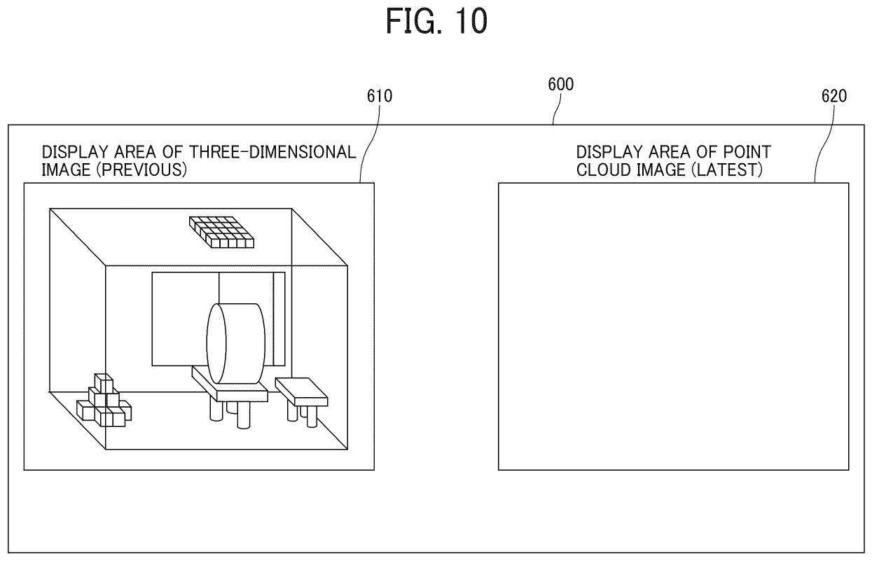

The communication terminal 3 displays a previous three-dimensional image (see FIG. 10) of the on-site conditions illustrated in FIG. 1. A user U visually compares the previous three-dimensional image with the latest (i.e., current) on-site conditions and searches for a changed portion in the latest on-site conditions compared to the previous three-dimensional image. The user U then moves the measurement apparatus 9, measures the changed portion to acquire data of a point cloud, which is the latest measurement result of the on-site conditions, and transmits the data of the point cloud to the server 7.

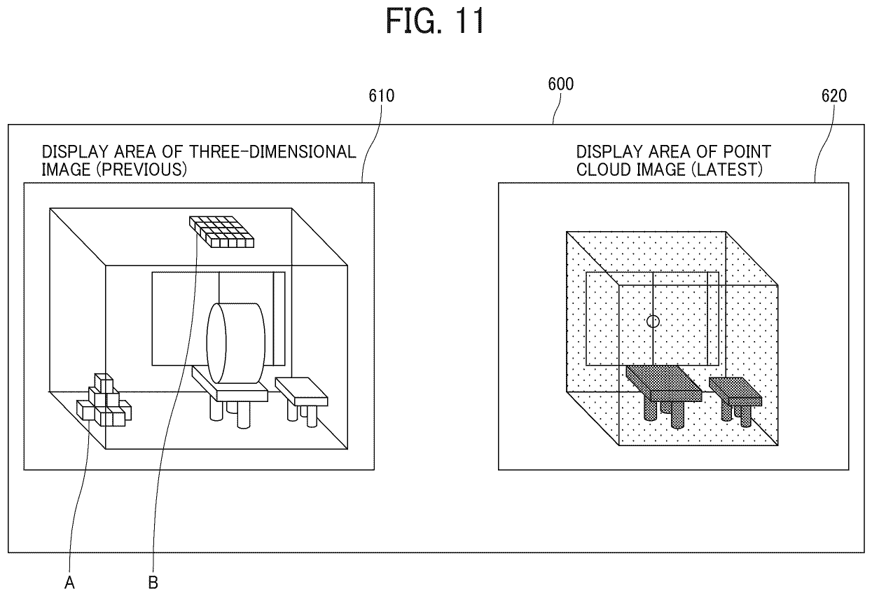

Further, the server 7 creates a latest point cloud image from the data of the latest point cloud and transmits the latest point cloud image to the communication terminal 3. The communication terminal 3 displays the previous three-dimensional image of the on-site conditions and the latest point cloud image of the same on-site conditions (see FIG. 11). Further details will be described below.

### Hardware Configurations

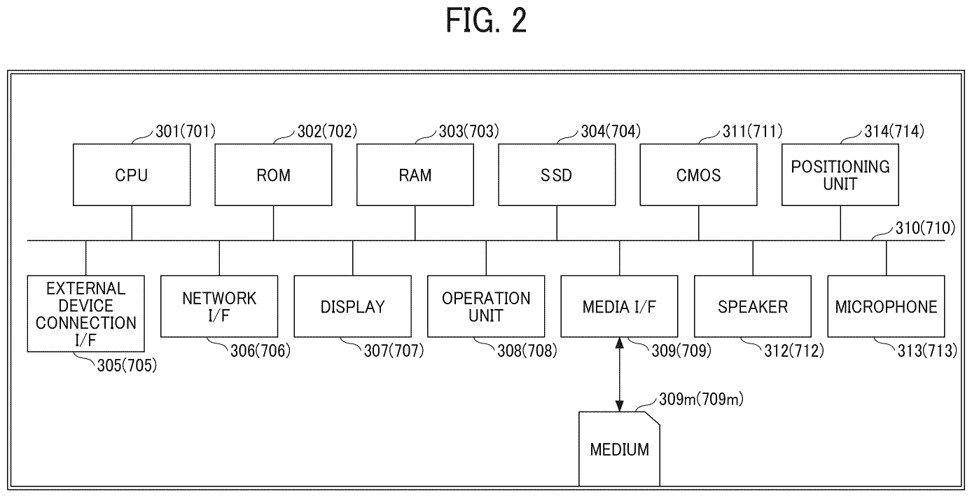

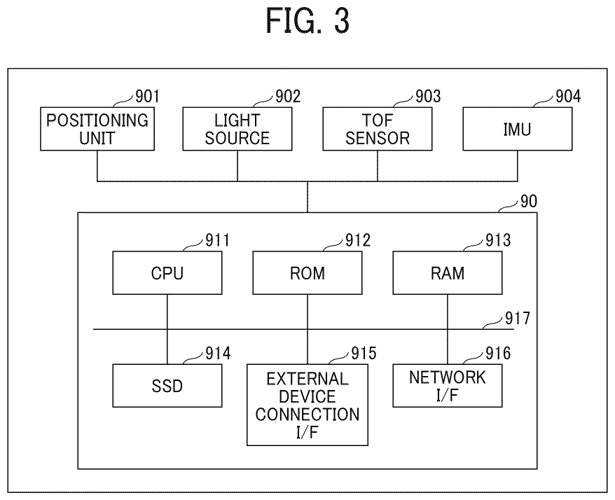

The hardware configurations of the communication terminal 3, the server 7, and the measurement apparatus 9 will be described below in detail with reference to FIGS. 2 and 3.

### Hardware Configuration of Communication Terminal

FIG. 2 illustrates an electrical hardware configuration of the communication terminal 3 and the server 7.

As illustrated in FIG. 2, the communication terminal 3 is a computer including a central processing unit (CPU) 301, a read only memory (ROM) 302, a random access memory (RAM) 303, a solid state drive (SSD) 304, an external device connection interface (I/F) 305, a network I/F 306, a display 307, an operation unit 308, a media I/F 309, a bus line 310, a complementary metal oxide semiconductor (CMOS) sensor 311, a speaker 312, a microphone 313, and a positioning unit 314.

The CPU 301 controls the overall operation of the communication terminal 3. The ROM 302 stores a program used for driving the CPU 301, such as an initial program loader (IPL). The RAM 303 is used as a work area for the CPU 301.

The SSD 304 reads or writes various types of data under the control of the CPU 301. The SSD 304 is optional when the communication terminal 3 is, for example, a smartphone. The communication terminal 3 may include a hard disk drive (HDD) in place of the SSD 304.

The external device connection I/F 305 is an interface for connecting to various external devices. The external devices include, but are not limited to, a display, a speaker, a keyboard, a mouse, a Universal Serial Bus (USB) memory, and a printer.

The network I/F 306 is an interface for performing data communication via the communication network 100.

The display 307 is a type of display device such as a liquid crystal display or an organic electroluminescent (EL) display that displays various images.

The operation unit 308 is an input device operated by a user to select or execute various instructions, select a target for processing, or move a cursor being displayed. Examples of the input device include various operation buttons, a power switch, a shutter button, and a touch panel.

The media I/F 309 controls reading or writing (storing) data from or to a recording medium 309m such as a flash memory. Examples of the recording medium 309m include a digital versatile disc (DVD) and a Blu-ray Disc™.

The CMOS sensor 311 is a type of imaging device for capturing an image of an object under the control of the CPU 301 to obtain image data. The communication terminal 3 may include a charge coupled device (CCD) sensor in place of the CMOS sensor 311.

The speaker 312 is a circuit that converts an electrical signal into physical vibration to generate sound such as music or voice.

The microphone 313 is a circuit that converts collected (captured) sound into sound (signal) data.

The positioning unit 314 receives a positioning signal including position information (latitude, longitude, and altitude) of the communication terminal 3 via a global navigation satellite system (GNSS) satellite such as a global positioning system (GPS) satellite or an indoor messaging system (IMES) serving as an indoor GPS. The positioning unit 314 may be a device dedicated to positioning or may be an application dedicated to positioning and installed in the communication terminal 3.

The bus line 310 is, for example, an address bus or a data bus for electrically connecting the components such as the CPU 301 to one another.

### Hardware Configuration of Server

The server 7 includes a CPU 701, a ROM 702, a RAM 703, an SSD 704, an external device connection I/F 705, a network I/F 706, a display 707, an operation unit 708, a media I/F 709, a bus line 710, a CMOS sensor 711, a speaker 712, a microphone 713, and a positioning unit 714. Since the CPU 701, the ROM 702, the RAM 703, the SSD 704, the external device connection I/F 705, the network I/F 706, the display 707, the operation unit 708, the media I/F 709, the bus line 710, the CMOS sensor 711, the speaker 712, the microphone 713, and the positioning unit 714 are the same or substantially the same as the CPU 301, the ROM 302, the RAM 303, the SSD 304, the external device connection I/F 305, the network I/F 306, the display 307, the operation unit 308, the media I/F 309, the bus line 310, the CMOS sensor 311, the speaker 312, the microphone 313, and the positioning unit 314, respectively, descriptions thereof will be omitted. The media I/F 709 controls reading or writing (storing) data from or to a recording medium 709m such as a flash memory. The recording medium 709m has a configuration similar to that of the recording medium 309m.

In the server 7, the CMOS sensor 711, the speaker 712, the microphone 713, and the positioning unit 714 are optional.

### Hardware Configuration of Measurement Apparatus

FIG. 3 illustrates an electrical hardware configuration of the measurement apparatus 9. The measurement apparatus 9 includes a positioning unit 901, a light source 902, a time-of-flight (TOF) sensor 903, an inertial measurement unit (IMU) 904, and a control device 90. The measurement apparatus 9 further includes, for example, a switch or a button. The measurement apparatus 9 may include a display.

The positioning unit 901 has a configuration similar to that of the positioning unit 314.

The light source 902 is a semiconductor laser, and emits laser light in a wavelength band other than the visible light range used for distance measurement (e.g., the infrared light range). The light source 902 is an example of a light projecting device.

The TOF sensor 903 measures reflected light resulting from laser light emitted from the light source 902 and reflected by an object to measure the distance from the light source 902 to the object.

The IMU 904 is a gyro sensor that detects, for example, the angle (i.e., position) and the angular velocity (or angular acceleration) of the measurement apparatus 9. The IMU 904 measures three-axis angle and angular velocity and acceleration that control the movement of the measurement apparatus 9. The IMU 904 is used to calculate the position of the moved measurement apparatus 9.

The control device 90 is a control device that controls the positioning unit 901, the light source 902, the TOF sensor 903, and the IMU 904. The control device 90 includes a CPU 911, a ROM 912, a RAM 913, an SSD 914, an external device connection I/F 915, a network I/F 916, and a bus line 917.

The CPU 911 controls the overall operation of the measurement apparatus 9. The CPU 911 reads, for example, a program, data, and setting information from, for example, the ROM 912 onto the RAM 913, and executes processing. All or some of operations implemented by the CPU 911, including control, the processing of image data, and various functions, may be implemented by a field-programmable gate array (FPGA) or an application-specific integrated circuit (ASIC).

The ROM 912 stores various programs, data, and various types of setting information, for example.

The RAM 913 is used as a work area for the CPU 911. The SSD 914 stores, for example, sensor data input from the TOF sensor 903 and the IMU 904. The measurement apparatus 9 may include an HDD in place of the SSD 914.

The external device connection I/F 915 is an interface for connecting to various external devices. The external device connection I/F 915 is connected to the communication terminal 3 and the server 7 in a wireless or wired manner to transmit and receive data or signals.

The network I/F 916 is an interface for performing data communication using the communication network 100, such as the Internet.

The bus line 917 is, for example, an address bus or a data bus for electrically connecting the components illustrated in FIG. 3, such as the CPU 911, to one another.

### Functional Configurations

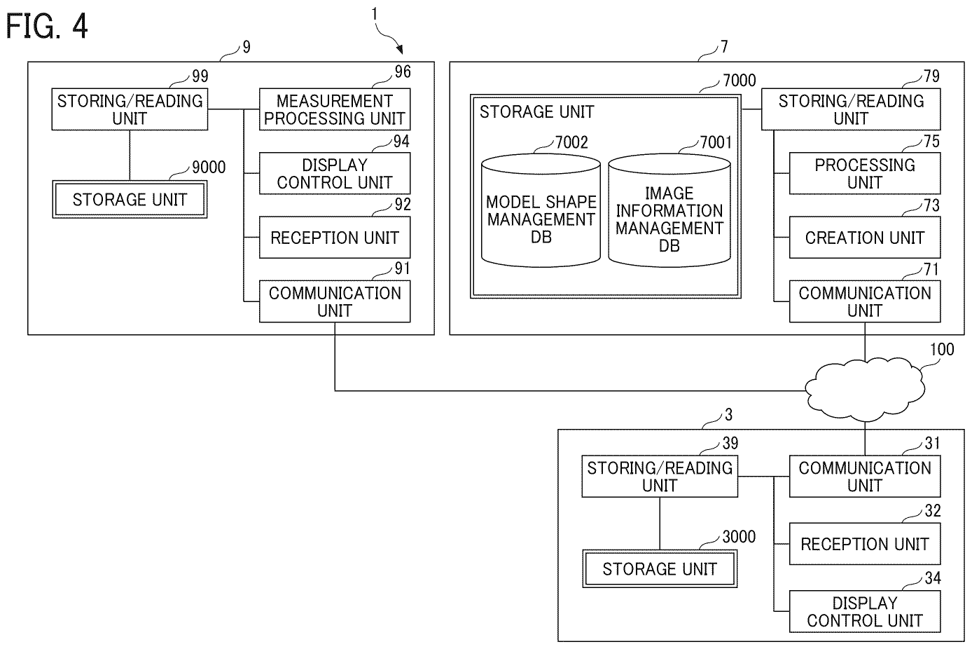

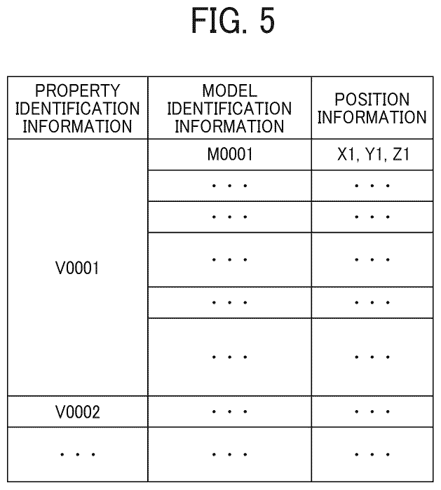

The functional components of the communication system 1 will be described below with reference to FIGS. 4 and 5. FIG. 4 illustrates the functional components of the communication system 1.

### Functional Configuration of Communication Terminal

As illustrated in FIG. 4, the communication terminal 3 includes a communication unit 31, a reception unit 32, a display control unit 34, and a storing/reading unit 39. Each unit is a function or means implemented by one or more of the hardware elements illustrated in FIG. 2 operating in accordance with instructions from the CPU 301 according to a program for the communication terminal 3 loaded onto the RAM 303 from the SSD 304. The communication terminal 3 further includes a storage unit 3000, which is implemented by the RAM 303 and (or) the SSD 304 illustrated in FIG. 2, for example.

In the communication terminal 3, the communication unit 31 is implemented by the network I/F 306 operating in accordance with instructions from the CPU 301 illustrated in FIG. 2. The communication unit 31 performs data communication with another device via the communication network 100.

The reception unit 32 is implemented by the operation unit 308 operating in accordance with instructions from the CPU 301. The reception unit 32 receives an instruction based on an operation input from the user (i.e., the user U). The reception unit 32 also functions as an acquisition unit and acquires an instruction provided through a user operation.

The display control unit 34 is implemented by operation of the CPU 301. The display control unit 34 controls the display 307 of the communication terminal 3 or an external display connected to the external device connection I/F 305 to display various images.

The storing/reading unit 39 is implemented by operation of the CPU 301. The storing/reading unit 39 stores various types of data (or information) in the storage unit 3000 or reads various types of data (or information) from the storage unit 3000.

### Functional Configuration of Server

As illustrated in FIG. 4, the server 7 includes a communication unit 71, a creation unit 73, a processing unit 75, and a storing/reading unit 79. Each unit is a function or means implemented by one or more of the hardware elements illustrated in FIG. 2 operating in accordance with instructions from the CPU 701 according to a program for the server 7 loaded onto the RAM 703 from the SSD 704. The server 7 further includes a storage unit 7000, which is implemented by the RAM 703 and (or) the SSD 704 illustrated in FIG. 2, for example. The storage unit 7000 stores the data of the point cloud transmitted from the measurement apparatus 9. Further, the storage unit 7000 includes two databases (DBs) for managing three-dimensional information. Specifically, the storage unit 7000 includes an image information management DB 7001 and a model shape management DB 7002.

### Image Information Management DB

FIG. 5 is an illustration of an image information management table. The image information management DB 7001 includes the image information management table illustrated in FIG. 5. The image information management table manages property identification information, model identification information, and position information in association with each other.

The property identification information is information for identifying each on-site property. When one site includes a plurality of properties, the property identification information differs for each property even at the same site. When one site includes one property, site identification information may be used instead of the property identification information.

The model identification information is an example of three-dimensional model identification information for identifying a three-dimensional model. The three-dimensional model is generated based on, for example, a point cloud acquired by the measurement apparatus 9.

The position information is information indicating the position of the three-dimensional model in a three-dimensional virtual space using three-dimensional coordinates of XYZ. For example, the position information is indicated by three-dimensional coordinates of eight points defining a rectangular parallelepiped space occupied by the three-dimensional model.

### Model Shape Management DB

The model shape management DB manages data of three-dimensional models each associated with corresponding model identification information.

### Functional Components of Server

The functional components of the server 7 will be described below in detail with reference to FIG. 4.

In the server 7, the communication unit 71 is implemented by the network I/F 706 operating in accordance with instructions from the CPU 701 illustrated in FIG. 2. The communication unit 71 performs data communication with another device via the communication network 100.

The creation unit 73 is implemented by operation of the CPU 701. The creation unit 73 creates a screen to be transmitted to the communication terminal 3 using, for example, the data stored in the storage unit 7000.

The processing unit 75 is implemented by operation of the CPU 701. The processing unit 75 performs various processes for the creation unit 73 to create a screen. The details of the various processes will be described below.

The storing/reading unit 79 is implemented by operation of the CPU 701. The storing/reading unit 79 stores various types of data (or information) in the storage unit 7000 or reads various types of data (or information) from the storage unit 7000.

### Functional Configuration of Measurement Apparatus

As illustrated in FIG. 4, the measurement apparatus 9 includes a communication unit 91, a reception unit 92, a display control unit 94, a measurement processing unit 96, and a storing/reading unit 99. Each unit is a function or means implemented by one or more of the hardware elements illustrated in FIG. 3 operating in accordance with instructions from the CPU 911 according to a program for the measurement apparatus 9 loaded onto the RAM 913 from the SSD 914. The measurement apparatus 9 further includes a storage unit 9000, which is implemented by the RAM 913 and (or) the SSD 914 illustrated in FIG. 3, for example.

In the measurement apparatus 9, the communication unit 91 is implemented by the network I/F 916 operating in accordance with instructions from the CPU 911 illustrated in FIG. 3. The communication unit 91 performs data communication with another device via the communication network 100.

The reception unit 92 is implemented by the switch or button of the measurement apparatus 9 operating in accordance with instructions from the CPU 911. The reception unit 92 receives an instruction based on an operation input from the user (i.e., the user U).

The display control unit 94 is implemented by operation of the CPU 911. The display control unit 94 controls the display of the measurement apparatus 9 or an external display connected to the external device connection I/F 915 to display various images.

The measurement processing unit 96 is implemented by the positioning unit 901, the light source 902, the TOF sensor 903, and the IMU 904 operating in accordance with instructions from the CPU 911. The measurement processing unit 96 identifies the position of the measurement apparatus 9 using the positioning unit 901, controls the irradiation timing of laser light from the light source 902, controls measurement by the TOF sensor 903, and controls measurement by the IMU 904.

The storing/reading unit 99 is implemented by operation of the CPU 911. The storing/reading unit 99 stores various types of data (or information) in the storage unit 9000 or reads various types of data (or information) from the storage unit 9000.

### Processes or Operations

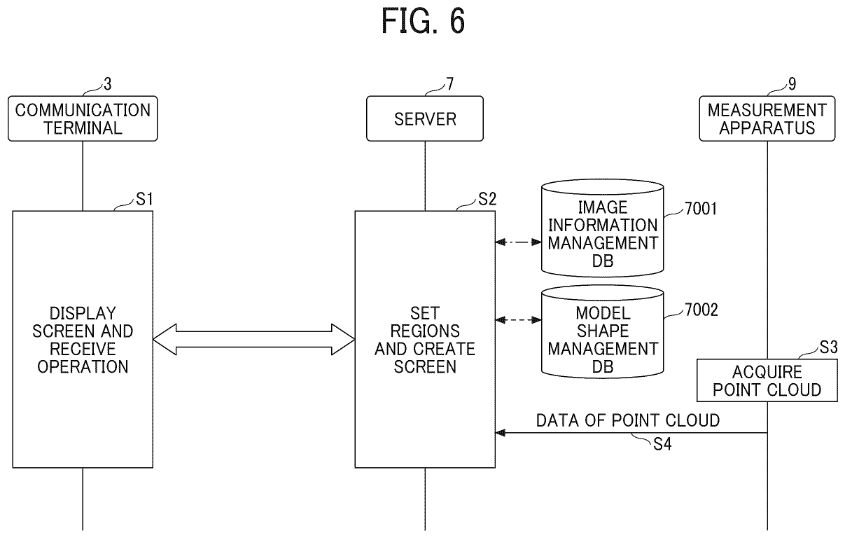

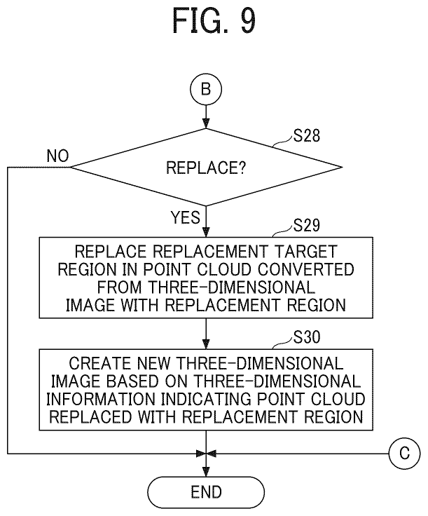

Examples of processes or operations will be described below with reference to FIGS. 6 to 13.

First, an overview of a screen creation and display process of the communication system 1 will be described with reference to FIG. 6. FIG. 6 is a sequence diagram illustrating a screen creation and display process of the communication system 1. In the following description, in a construction site as illustrated in FIG. 1, the server 7 causes the communication terminal 3 to display a previous three-dimensional image and a point cloud image based on the data of the latest point cloud acquired from the measurement apparatus 9.
S1: The communication terminal 3 performs data communication with the server 7 to display a screen, receive an input operation from the user U, and transmit input information based on the input operation to the server 7. For example, the user U operates the communication terminal 3 at a construction site and requests the server 7 to transmit data of a previous three-dimensional image of the same construction site. The request includes property identification information for identifying a property at the construction site. Thus, the communication unit 71 of the server 7 receives the request for the data of the three-dimensional image.
S2: The server 7 performs data communication with the communication terminal 3 to set a replacement region and a replacement target region described below and create a screen. In this case, the server 7 uses the image information management DB 7001 and the model shape management DB 7002.
S3: During the processing of steps S1 and S2, a screen 600 illustrated in FIG. 10, which is received from the server 7, is displayed on the communication terminal 3 at the construction site. The user U visually compares the previous three-dimensional image displayed in a display area 610 with the latest conditions of the construction site to understand a changed portion in the latest conditions compared to the previous three-dimensional image. Then, in response to the user U operating the measurement apparatus 9, the measurement processing unit 96 processes a result of measuring some of the latest conditions of the construction site, including the changed portion compared to the previous three-dimensional image, with the TOF sensor 903 and acquires data of a point cloud.
S4: The communication unit 91 of the measurement apparatus 9 transmits the data of the latest point cloud acquired in step S3 to the server 7 via the communication network 100. Thus, in the server 7, the communication unit 71 receives the data of the latest point cloud, and the processing unit 75 and the creation unit 73 create a point cloud image to be displayed in a display area 620, as illustrated in FIG. 11. The display area 610 is an example of a first display area, and the display area 620 is an example of a second display area.

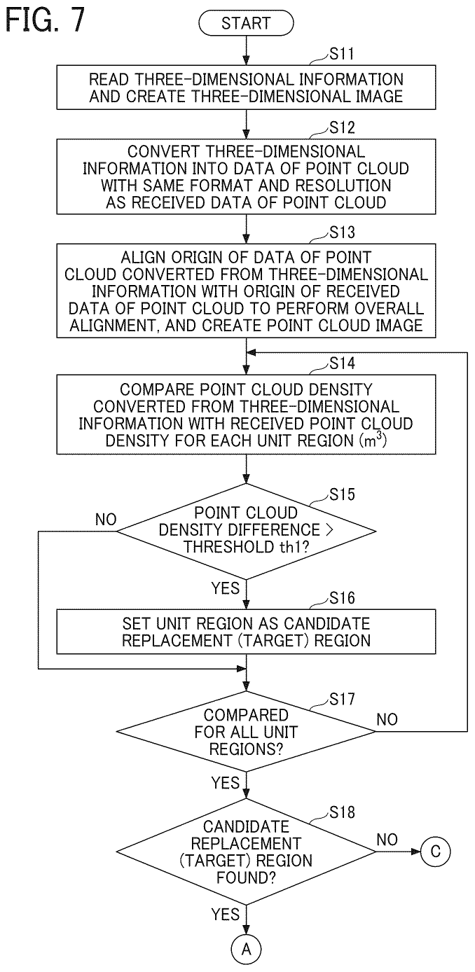

The processing of step S2, which is performed by the server 7, will be described in detail with reference to FIGS. 7 to 9. FIGS. 7 to 9 are a flowchart illustrating a process executed by the server 7.

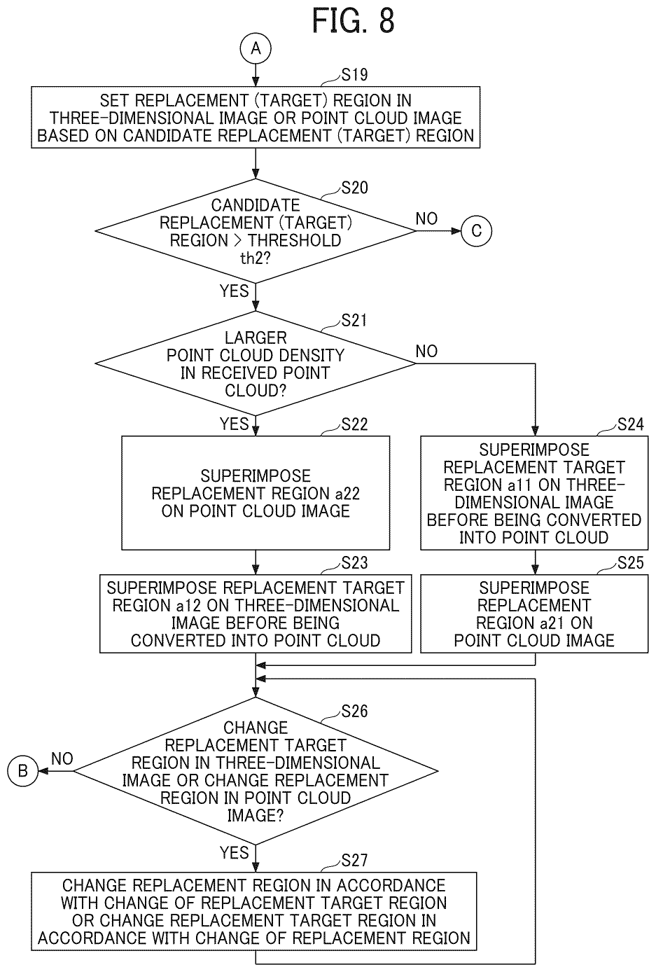

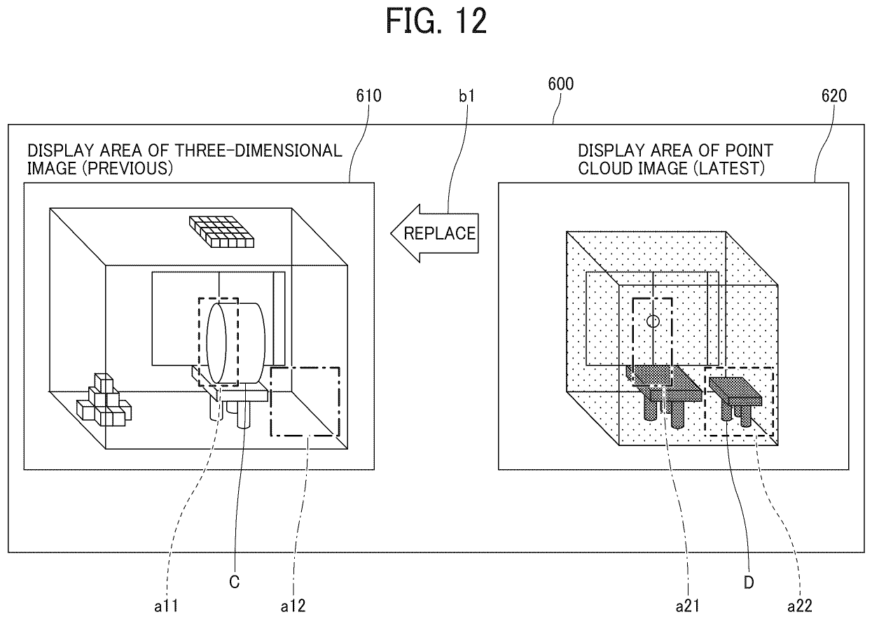

In the following description, in response to the processing unit 75 of the server 7 executing various processes, the creation unit 73 creates the screen 600, which is based on the various processes, and the communication unit 71 transmits the data of the screen 600 to the communication terminal 3. Thus, in the communication terminal 3, the display control unit 34 causes the display 307 to display the screen 600.
S11: Based on the property identification information received from the communication terminal 3, the processing unit 75 reads model identification information and position information of each three-dimensional model from the image information management DB 7001 and reads the previous three-dimensional information corresponding to the read model identification information from the model shape management DB 7002. Then, the creation unit 73 creates the screen 600 as illustrated in FIG. 10. FIG. 10 illustrates an example of an initial state of the screen 600 displayed on the communication terminal 3. As illustrated in FIG. 10, the screen 600 includes the display area 610 on the left side thereof and the display area 620 on the right side thereof. The display area 610 displays the previous three-dimensional image, and the display area 620 displays a point cloud image created from the data of the latest point cloud. In the point in time of the processing of step S11, the previous three-dimensional image is displayed in the display area 610, but no image is displayed in the display area 620. By visually comparing the previous three-dimensional image displayed in the display area 610 with the latest conditions of the construction site, the user U can understand a changed portion in the latest conditions of the construction site compared to the previous three-dimensional image.
S12: The processing unit 75 converts the previous three-dimensional information into data of a point cloud having the same format and resolution as the data of the point cloud received in step S4.
S13: The processing unit 75 aligns the origin of the data of the point cloud converted from the previous three-dimensional information in step S12 with the origin of the data of the latest point cloud received in step S4 to perform overall alignment. Then, the creation unit 73 creates a point cloud image from the data of the latest point cloud received in step S4 to create a screen 600 illustrated in FIG. 11. FIG. 11 illustrates an example of a point cloud image additionally displayed on the communication terminal 3 based on the data of the point cloud. As illustrated in FIG. 11, a point cloud image created from the data of the latest point cloud received in step S4 is additionally displayed in the display area 620, whereas the content displayed in the display area 610 remains unchanged.
S14: The processing unit 75 compares, for each unit region (in m³) a, the point cloud density of a point cloud converted from the previous three-dimensional information with the point cloud density of the latest point cloud whose data is received in step S4.
S15: The processing unit 75 determines whether the difference between the point cloud densities is greater than a threshold th1 through the comparison in step S14.
S16: If the difference between the point cloud densities is greater than the threshold th1 in step S15, the processing unit 75 sets the unit region a as a candidate replacement target region. The processing unit 75 may set the unit region a as a candidate replacement region.
S17: If the difference between the point cloud densities is less than or equal to the threshold th1 in step S15 or after the processing of step S16, the processing unit 75 determines whether the point cloud densities have been compared for all the unit regions in an overlapping area between the point cloud of the previous three-dimensional image and the point cloud of the latest point cloud image. If the point cloud densities have not been compared for all the unit regions (NO), the process returns to step S14.
S18: If the point cloud densities have been compared for all the unit regions in step S17 (YES), the processing unit 75 determines whether a candidate replacement region (or a candidate replacement target region) is found. If no candidate replacement region is found (or no candidate replacement target region is found) (NO), the processing of step S2 ends.
S19: If a candidate replacement region (or a candidate replacement target region) is found in step S18 (YES), in FIG. 8, the processing unit 75 sets a replacement target region in the previous three-dimensional image or a replacement region in the latest point cloud image, based on the candidate replacement region (or the candidate replacement target region). For example, the processing unit 75 sets a replacement target region or a replacement region by using a plurality of adjacent unit regions a1 and a2. The unit regions a1 and a2 are examples of the unit region described above.
S20: The processing unit 75 determines whether the size (in m³) of the replacement region (or the replacement target region) is greater than a threshold th2. If the size (in m³) of the replacement region (or the replacement target region) is less than or equal to the threshold th2, the processing unit 75 determines that the changed portion in the latest point cloud image compared to the previous three-dimensional image is minute, and then the processing of step S2 ends.
S21: If the size (in m³) of the replacement region (or the replacement target region) is greater than the threshold th2 in step S20 (YES), the processing unit 75 determines whether, among the replacement region and the replacement target region, the point cloud density is larger in the replacement region in the latest point cloud whose data is received in step S4. The processing unit 75 may perform image recognition to determine the sizes of the replacement region and the replacement target region.
S22: If the processing unit 75 determines in step S21 that the point cloud density is larger in the replacement region in the latest point cloud (YES), for example, as illustrated in FIG. 12, the processing unit 75 superimposes a replacement region a22 on the point cloud image in the display area 620.
S23: The processing unit 75 further superimposes a replacement target region a12 on the three-dimensional image not yet converted into the point cloud in the display area 610, for example, at a position corresponding to the replacement region a22.
S24: If the processing unit 75 determines in step S21 that the point cloud density is larger in the replacement target region rather than in the replacement region (NO), the processing unit 75 superimposes, for example, a replacement target region a11 on the three-dimensional image not yet converted into the point cloud in the display area 610.
S25: The processing unit 75 superimposes a replacement region a21 on the point cloud image in the display area 620, for example, at a position corresponding to the replacement target region a11.

In FIG. 12, the replacement target regions a11 and a12 and the replacement regions a21 and a22 are indicated by bounding boxes. As an example, the replacement target region a11 and the replacement region a22 are displayed in a display style (e.g., a dashed-line frame) indicating the presence of an object, and the replacement target region a12 and the replacement region a21 are displayed in a display style (e.g., a dash-dot frame) indicating the absence of an object.

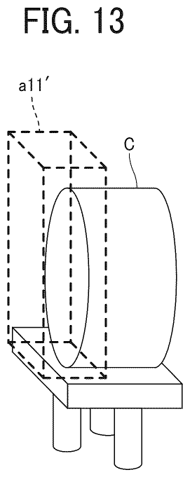

While the replacement target region a11 is displayed in a two-dimensional (i.e., planar) manner, a three-dimensional (i.e., solid) replacement target region a11′ as illustrated in FIG. 13 may be displayed. In this case, a three-dimensional bounding box is displayed. The same applies to the three-dimensional representations of the replacement target region a12 and the replacement regions a21 and a22.

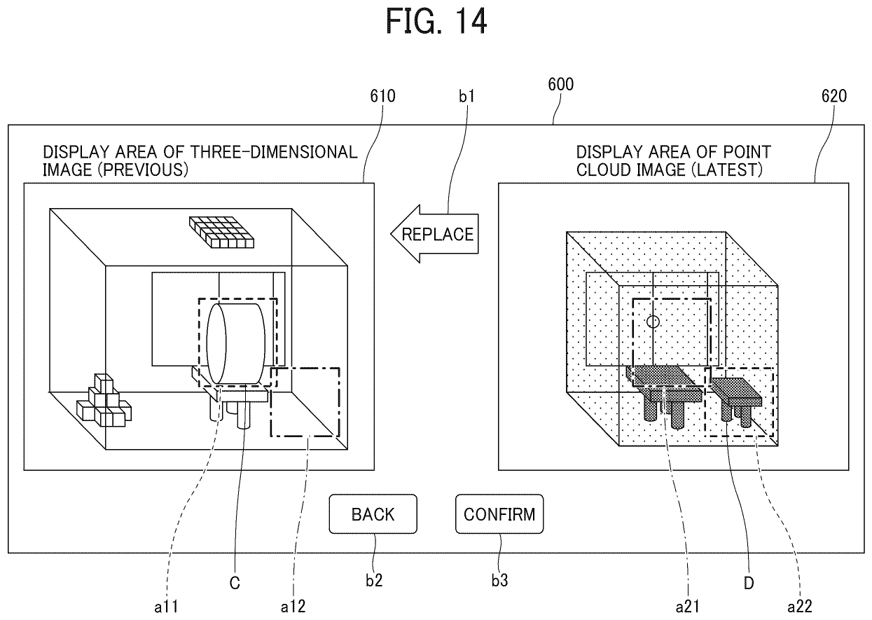

As illustrated in FIG. 12, furthermore, the replacement target region a11, which would include the entirety of an object C, does not fully include the object C depending on the point cloud density. To address this situation, the user U operates the communication terminal 3 to change (e.g., enlarge, reduce, or move) the replacement target region a11 currently displayed on the communication terminal 3 as illustrated in FIG. 14. Then, the reception unit 32 receives the change, and the communication unit 31 transmits input information indicating the content of the change to the server 7. FIG. 14 illustrates an example of the changed replacement target region a11 on the communication terminal 3.
S26: In the server 7, the processing unit 75 determines whether a replacement target region (e.g., the replacement target region a11) in the previous three-dimensional image has undergone a change or a replacement region (e.g., the replacement region a22) in the latest point cloud image has undergone a change.
S27: The processing unit 75 changes a replacement region (e.g., the replacement region a21) in the point cloud image in accordance with the change of the replacement target region (e.g., the replacement target region a11) in the three-dimensional image. Alternatively, the processing unit 75 changes a replacement target region (e.g., the replacement target region a12) in the three-dimensional image in accordance with the change of the replacement region (e.g., the replacement region a22) in the point cloud image. Accordingly, the creation unit 73 changes the display style of the replacement target region (e.g., the replacement target region a11) and also changes the replacement region (e.g., the replacement region a21). Alternatively, the processing unit 75 changes the display style of the replacement region (e.g., the replacement region a22) and also changes the replacement target region (e.g., the replacement target region a12).

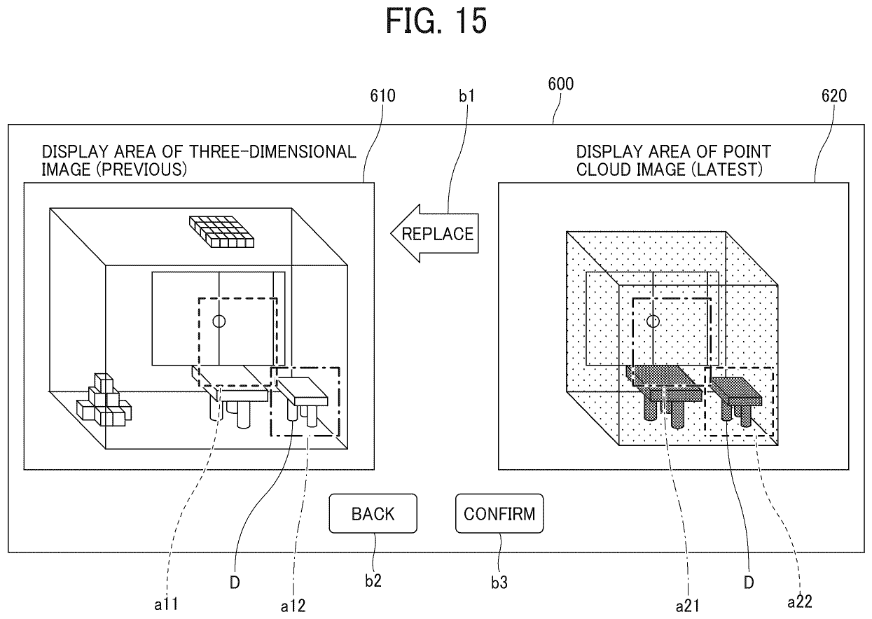

At this time, the user U operates the communication terminal 3 and selects a “Replace” button b1 when the extent of the region such as the replacement target region a11 changed and displayed on the communication terminal 3 is appropriate. Then, as illustrated in FIG. 14, a “Back” button b2 and a “Confirm” button b3 are displayed. In response to the user U selecting the “Confirm” button b3, the reception unit 32 of the communication terminal 3 receives the replacement operation, and the communication unit 31 of the communication terminal 3 transmits input information indicating the replacement operation to the server 7. Thus, the communication unit 71 receives the input information indicating the replacement operation. In response to the “Back” button b2 being selected, as illustrated in FIG. 12, the original replacement target region a11 and the original replacement region a21 before the change are again displayed.
S28: In the server 7, the processing unit 75 determines whether to perform replacement. For example, in a case where the “Confirm” button b3 is not selected even after a predetermined amount of time (e.g., three minutes) has elapsed since the selection of the “Replace” button b1, or in a case where the screen 600 is forcibly closed, the processing unit 75 determines not to perform replacement. Then, the processing of step S2 ends.
S29: If replacement is to be performed in step S28 (YES), the processing unit 75 replaces a replacement target region (e.g., the replacement target regions a11 and a12) in the point cloud converted from the previous three-dimensional information with a corresponding replacement region (e.g., the replacement regions a21 and a22) on the latest point cloud image.
S30: As illustrated in FIG. 15, the creation unit 73 creates a new three-dimensional image based on the three-dimensional information indicating the point cloud replaced with the replacement region (e.g., the replacement regions a21 and a22). The new three-dimensional image includes, as illustrated in FIG. 15, the display area 610 in which the object C in the replacement target region a11 is not displayed (i.e., the object C is deleted) and in which the same object as an object D in the replacement region a22 is displayed in the replacement target region a12.

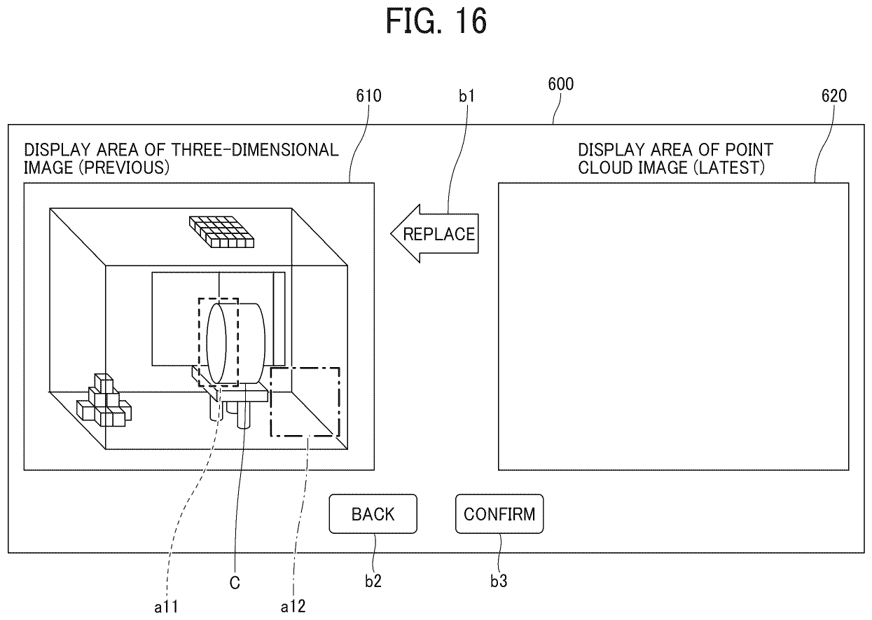

In step S13, a point cloud image is displayed in the display area 620 in FIG. 11, and, also in steps S23 and S25, a point cloud image is displayed in the display area 620 in FIG. 12. Alternatively, as illustrated in FIG. 16, the display area 610 may provide a display, whereas the display area 620 does not provide a display. This is because the user U can roughly understand the presence of replacement target regions as long as the replacement target regions a11 and a12 are displayed. In this case, based on the selection of the “Replace” button b1, as illustrated in FIG. 14, the display control unit 34 displays a point cloud image in the display area 620.

As described above, according to the present embodiment, as long as the measurement apparatus 9 does not measure the entire areas at the same site as the previously measured site but measures an area where a target object is different from that in the previous three-dimensional image, as illustrated in FIG. 12, the server 7 can visually present an area (e.g., the replacement target regions a11 and a12) changed between the previous three-dimensional image and a point cloud image obtained by the latest measurement at the site to the user U. Then, as illustrated in FIG. 14, the user U performs, for example, adjustment of the replacement target region a11 and then finally replaces the replacement target region in the previous three-dimensional image with the replacement region in the latest point cloud image of the site. This enables omission of the latest measurement of the entire on-site areas. Thus, the latest information on even a location such as an on-site environment where conditions change can be obtained through efficient measurement.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

In the processing of step S13 described above, the processing unit 75 aligns the origin of the data of the point cloud converted from the previous three-dimensional information with the origin of the data of the latest point cloud to perform overall alignment, by way of example but not limitation. For example, to increase the accuracy of alignment, the communication terminal 3 or any other image capturing device such as a digital camera may be used to capture both previous and current images of the same site, and image matching may be performed between the images. Specifically, the processing unit 75 extracts feature points from the data of the point cloud converted from the previous three-dimensional information and feature points from the data of the latest point cloud, and represents the shapes and spatial positional relationships of the feature points as line graphics. Then, the line graphics are superimposed on each other based on the similarity in structure between the line graphics.

As another example of the processing of step S19, the processing unit 75 may set a replacement target region or a replacement region in an area where a category classified by the semantic segmentation processing of a point cloud is different from a category classified by the semantic segmentation processing of another point cloud corresponding to a three-dimensional image.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The programs described above may be stored in (non-transitory) recording media such as digital versatile disc-read only memories (DVD-ROMs), and such (non-transitory) recording media may be provided in the form of program products to domestic or foreign users.

The CPUs 301, 701, and 911 serving as processors may each include multiple processors.

1. An information processing apparatus comprising circuitry configured to:
create a three-dimensional image indicating a replacement target region, the replacement target region being replaceable with a replacement region included in a point cloud obtained by measuring a target object;
replace the replacement target region with the replacement region, based on received input information; and
create a screen including the three-dimensional image.

2. The information processing apparatus according to claim 1, wherein the circuitry is configured to create the three-dimensional image having the replacement target region replaced with the replacement region.

3. The information processing apparatus according to claim 2, wherein the circuitry is configured to create the screen, the screen including a point cloud image that is based on the point cloud and the three-dimensional image that is aligned with the point cloud.

4. The information processing apparatus according to claim 3, wherein the circuitry is configured to match a feature point in the point cloud image with a feature point in a point cloud image converted from the three-dimensional image to align the point cloud image and the three-dimensional image with each other.

5. The information processing apparatus according to claim 3, wherein the circuitry is configured to create the screen such that the point cloud image indicates the replacement region.

6. The information processing apparatus according to claim 1, wherein the circuitry is configured to:
change a region in the replacement target region, based on the received input information; and
create the three-dimensional image in which the region in the replacement target region has been changed.

7. The information processing apparatus according to claim 5, wherein the circuitry is configured to set the replacement region and the replacement target region, based on a point cloud density of the point cloud and a point cloud density of a point cloud converted from the three-dimensional image.

8. The information processing apparatus according to claim 7, wherein the circuitry is configured to:
determine a display style of at least one of the replacement region in the point cloud image or the replacement target region in the three-dimensional image, based on a result of comparison between a point cloud density in the replacement region and a point cloud density in the replacement target region; and
create the screen in the determined display style.

9. A communication system comprising:
the information processing apparatus according to claim 1; and
a measurement apparatus to transmit data of the point cloud obtained by measuring the target object to the information processing apparatus.

10. A communication system comprising:
the information processing apparatus according to claim 1; and
a communication terminal to cause a display to display the three-dimensional image.

11. An information processing method comprising:
creating a three-dimensional image indicating a replacement target region, the replacement target region being replaceable with a replacement region included in a point cloud obtained by measuring a target object;
replacing the replacement target region with the replacement region, based on received input information; and
creating a screen including the three-dimensional image.

12. A non-transitory recording medium storing a plurality of instructions which, when executed by one or more processors, causes the one or more processors to perform an information processing method comprising:
creating a three-dimensional image indicating a replacement target region, the replacement target region being replaceable with a replacement region included in a point cloud obtained by measuring a target object;
replacing the replacement target region with the replacement region, based on received input information; and
creating a screen including the three-dimensional image.
